(19) United States
(12) Patent Application Publication
(10) Pub. No.: US 2023/0242079 A1
(43) Pub. Date: Aug. 3, 2023

(54) RAINDROP DETECTION DEVICE

(71) Applicant: DENSO CORPORATION, Kariya-city (JP)

(72) Inventors: KEIGO HIKIDA, Kariya-city (JP); TAKAMITSU OKURA, Kariya-city (JP); KIYOSHI OTSUKA, Kariya-city (JP); YOSHIHISA BANNO, Kariya-city (JP); KAZUMASA NAKAJIMA, Kariya-city (JP); MASAAKI INOGUCHI, Kariya-city (JP)

(21) Appl. No.: 18/297,842

(22) Filed: Apr. 10, 2023

Related U.S. Application Data
(63) Continuation of application No. PCT/JP2021/038181, filed on Oct. 15, 2021.

(30) Foreign Application Priority Data
Nov. 6, 2020 (JP) 2020-185627

(51) Int. Cl. B60S 1/08; B60S 1/54

(52) U.S. Cl. CPC B60S 1/0844; B60S 1/0866; B60S 1/54

(57) ABSTRACT

A raindrop detection device includes: a front monitoring camera for photographing a front of a vehicle through a windshield of the vehicle; a raindrop detection camera for photographing a raindrop adhering to the windshield; and an electronic control unit disposed away from the windshield, the front monitoring camera, and the raindrop detection camera, performing an image processing on an image data of a front image from the front monitoring camera, and performing an image processing on an image data of a windshield image from the raindrop detection camera.

### CROSS REFERENCE TO RELATED APPLICATIONS

The present application is a continuation application of International Patent Application No. PCT/JP2021/038181 filed on Oct. 15, 2021, which designated the U.S. and claims the benefit of priority from Japanese Patent Application No. 2020-185627 filed on Nov. 6, 2020. The entire disclosures of all of the above applications are incorporated herein by reference.

### TECHNICAL FIELD

The present disclosure relates to a raindrop detection device.

### BACKGROUND

A vehicle camera system in which a first camera module, a second camera module, and a semiconductor device are housed in one casing has been proposed, for example, as a conceivable technique.

The first camera module captures an area in front of the vehicle. The second camera module captures rain or raindrops. The semiconductor device performs image processing tasks. The semiconductor device performs not only an image processing of an image captured by the first camera module, but also an image processing of an image captured by the second camera module.

### SUMMARY

According to an example, a raindrop detection device may include: a front monitoring camera for photographing a front of a vehicle through a windshield of the vehicle; a raindrop detection camera for photographing a raindrop adhering to the windshield; and an electronic control unit disposed away from the windshield, the front monitoring camera, and the raindrop detection camera, performing an image processing on an image data of a front image from the front monitoring camera, and performing an image processing on an image data of a windshield image from the raindrop detection camera.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a block diagram showing a raindrop detection device according to a first embodiment;

FIG. 2 is a schematic diagram of a windshield;

FIG. 3 is a diagram showing a front view of a front monitoring camera according to a second embodiment;

FIG. 4 is a diagram showing a raindrop detection camera according to a second embodiment;

FIG. 5 is a diagram showing the internal configuration of a raindrop detection camera;

FIG. 6 is a diagram showing a view of one side of the circuit board shown in FIG. 5;

FIG. 7 is a diagram showing the inside of the raindrop casing;

FIG. 8 is a diagram showing the view angle of the front monitoring camera and the raindrop detection camera;

FIG. 9 is a diagram showing a state in which the circuit board is fixed to the raindrop casing;

FIG. 10 is a diagram showing the depth of field of the raindrop detection camera according to the third embodiment;

FIG. 11 is a diagram showing a photographing range of the raindrop detection camera according to a fourth embodiment;

FIG. 12 is a diagram showing a sky detection range and a raindrop detection range of a windshield image;

FIG. 13 is a diagram showing the relationship between the average brightness value and the illuminance;

FIG. 14 is a diagram showing a sky region above the vehicle and a sky region in front of the vehicle in the windshield image;

FIG. 15 is a diagram showing an example of a windshield image in a case where it is determined when turning off the light;

FIG. 16 is a diagram showing an example of a windshield image in a case where it is determined when turning off the light;

FIG. 17 is a diagram showing an example of a windshield image in a case where it is determined when turning on the light;

FIG. 18 is a diagram for explaining a modification according to the fourth embodiment;

FIG. 19 is a diagram for explaining a modification according to the fourth embodiment;

FIG. 20 is a diagram showing magnification change of a windshield image according to the fifth embodiment;

FIG. 21 is a diagram for explaining a modification according to the fifth embodiment;

FIG. 22 is a diagram for explaining a modification according to the fifth embodiment;

FIG. 23 is a diagram showing a recognition result of raindrops on the windshield image according to the sixth embodiment;

FIG. 24 is a diagram showing the relationship between the raindrop adhesion rate and the wiping speed of the wiper according to the sixth embodiment;

FIG. 25 is a diagram showing a raindrop according to the seventh embodiment;

FIG. 26 is a diagram showing an entrance of a tunnel according to a seventh embodiment;

FIG. 27 is a diagram showing an exit of the tunnel according to the seventh embodiment;

FIG. 28 is a diagram showing a bridge girder according to the seventh embodiment;

FIG. 29 is a diagram showing a front image according to the ninth embodiment;

FIG. 30 is a diagram for explaining a modification according to the ninth embodiment;

FIG. 31 is a diagram for explaining a modification according to the ninth embodiment;

FIG. 32 is a diagram for explaining a modification according to the ninth embodiment;

FIG. 33 is a diagram for explaining a modification according to the ninth embodiment;

FIG. 34 is a diagram showing a front image according to the tenth embodiment;

FIG. 35 is a diagram showing a front image according to the tenth embodiment;

FIG. 36 is a diagram showing the view angle of the front monitoring camera according to the eleventh embodiment;

FIG. 37 is a diagram for explaining a modification according to the eleventh embodiment;

FIG. 38 is a diagram for explaining a modification according to the eleventh embodiment;

FIG. 39 is a diagram for explaining another embodiment;

FIG. 40 is a diagram for explaining another embodiment;

FIG. 41 is a diagram for explaining another embodiment; and

FIG. 42 is a diagram for explaining another embodiment.

### DETAILED DESCRIPTION

In the conceivable technology described above, the first camera module, the second camera module, and the semiconductor device are all accommodated in the one casing. Moreover, since the semiconductor device is shared by each camera module, the circuit design of each camera module with respect to the semiconductor device may become complicated. Therefore, the size of the casing may become large. Since the space near the rearview mirror of the vehicle in which the camera system is arranged is small, it is desirable to reduce the size of the casing.

In the conceivable technique described above, the two camera modules are integrated, so the image processing tasks of the semiconductor device may increase. As a result, the temperature around the semiconductor device may rise due to the heat generated by the semiconductor device. As a result, the environment may become difficult to measure the humidity in the vicinity of the windshield. Also, although rain and raindrops are photographed by the second camera module, fogging of the windshield may not be detected. Therefore, information on the humidity near the windshield is required.

In the conceivable technology described above, the first camera module is accommodated in the casing so as to photograph the front of the vehicle, while the second camera module is accommodated in the casing so as to photograph raindrops adhering to the windshield and the sky. Since the inclination angle of the windshield differs from vehicle to vehicle, it may be necessary to prepare a plurality of casings so that the photographing direction of the second camera module corresponds to the inclination angle of the windshield. For this reason, a plurality of variations may occur for the casing.

In the above conceivable technique, the second camera module is focused on the windshield to photograph the rain and raindrops. Since the inclination angle of the windshield differs from vehicle to vehicle, if the arrangement angle of the second camera module changes, the second camera module may not be focused.

In the conceivable technology described above, rain and raindrops are photographed by the second camera module, but no method has been proposed for realizing the same functions as the sunshine sensor or the light sensor based on the image of the second camera module. Since the brightness in the image differs depending on what is being photographed, such as roads and lighting, it may be difficult to uniquely turn on/off the light of the vehicle based on the brightness of the image of the second camera module.

Also, when the same function as that of the sun light sensor is realized based on the image of the second camera module, it may be difficult to estimate the direction and intensity of the sun light if the sun is not captured in the image. It is conceivable to use a dedicated lens such as a fish-eye lens to capture the sun in the image, but this may increase the cost. Alternatively, when the sun is photographed in the image, the surroundings of the sun in the image may be overexposed. In this case, high dynamic range synthesis processing is required to eliminate brown-out highlights and blocked-up shadows in a single image and indicate bright and dark portions simultaneously while leaving gradation.

Furthermore, the brightness of a plurality of subjects captured in an image may differ depending on the color of each subject even if the surrounding brightness is the same. Therefore, it may be difficult to turn on/off the light of the vehicle based on the image.

Here, a narrow angle of view may be required in order to capture rain or raindrops with a single second camera module, while a wide angle of view may be required in order to capture images as a sun-light sensor or a light sensor. Therefore, if a wide angle of view is adopted for the second camera module, it may become difficult to photograph rain and raindrops.

In the conceivable technology described above, the photographing range of the second camera module is narrow. For this reason, it may be difficult to control the wiper of the vehicle when raindrops do not adhere to the photographing range of the second camera module of the windshield. For example, raindrops flowing from the ceiling of the vehicle onto the windshield may fall outside the photographing range of the second camera module. In this way, the state of the windshield viewed by the user differs from the state of the range of the windshield being photographed, it may be difficult to satisfy the user's request for wiping.

Alternatively, when controlling the wiper based on the brightness of the image captured by the second camera module may cause the wiper to continue wiping dry after entering the tunnel. Therefore, the user feels annoyed.

Although the first camera module captures an image of the road in front of the vehicle, the conceivable technology described above does not provide a method for sharing road conditions with other vehicles.

The main object of the present embodiments is to provide a raindrop detection device capable of realizing a downsized casing arranged on a windshield.

According to one aspect of the present embodiments, a rain detection device includes a front monitoring camera, a raindrop detection camera, and an electronic control unit.

The front monitoring camera captures an image of the front of the vehicle through the windshield of the vehicle. The raindrop detection camera captures an image of raindrops on the windshield.

The electronic control unit is located away from the windshield, the front monitoring camera, and the raindrop detection camera, and performs image processing on the image data of the front image from the front monitoring camera, and performs image processing on the image data of the windshield image from the raindrop detection camera.

According to this, the electronic control unit is located at a distance from the windshield, the front monitoring camera and the raindrop detection camera. Therefore, it is not necessary for the windshield to provide space for arranging the electronic control unit. Therefore, it is possible to reduce the size of the casing arranged on the windshield.

Hereinafter, embodiments for implementing the present disclosure will be described referring to drawings. In the respective embodiments, parts corresponding to matters already described in the preceding embodiments are given reference numbers identical to reference numbers of the matters already described. The same description is therefore omitted depending on circumstances. In a case where only a part of the configuration is described in each embodiment, the other embodiments described above can be applied to the other part of the configuration. The parts may be combined even if it is not explicitly described that the parts can be combined. The embodiments may be partially combined even if it is not explicitly described that the embodiments can be combined, provided there is no harm in the combination.

### First Embodiment

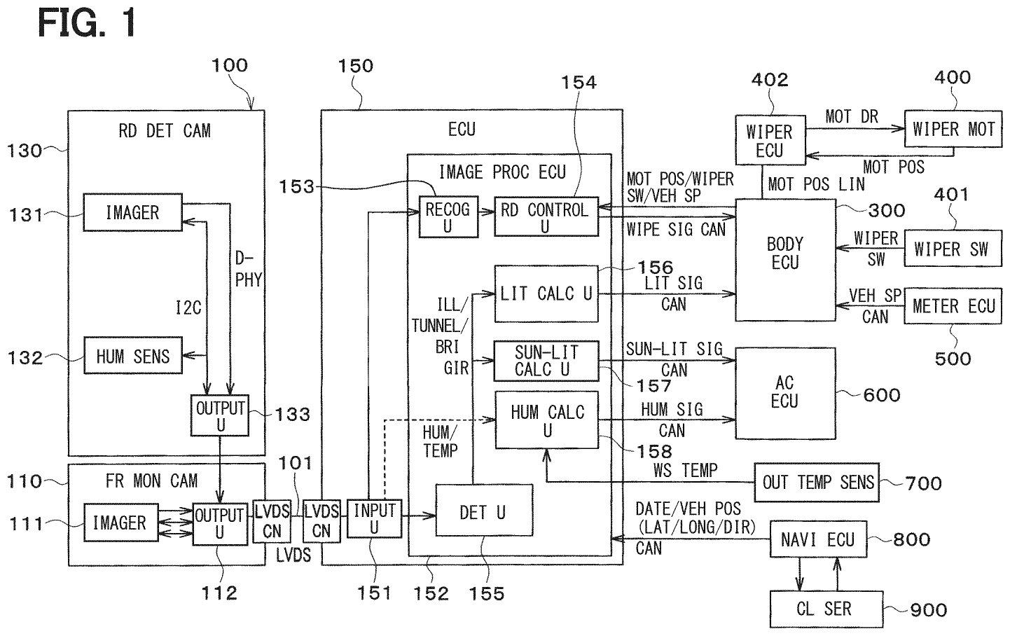

Hereinafter, a first embodiment will be described with reference to the drawings. As shown in FIG. 1, the raindrop detection device 100 includes a front monitoring camera 110, a raindrop detection camera 130 and an electronic control unit 150. The front monitoring camera 110 and the electronic control unit 150 constitute an advanced driver assistance system (ADAS).

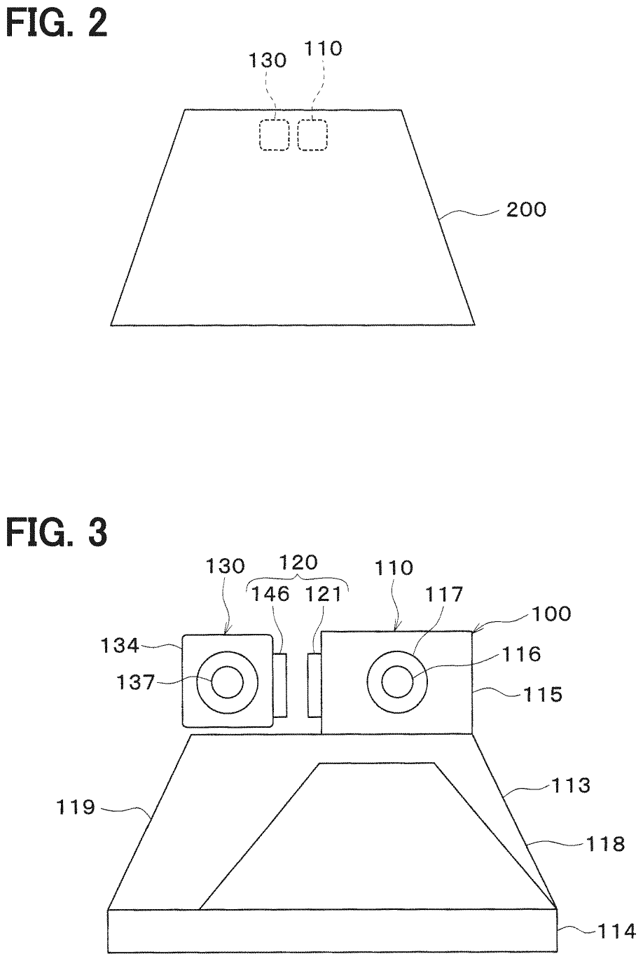

As shown in FIG. 2, the front monitoring camera 110 and the rain detection camera 130 are arranged on the windshield 200 of the vehicle. The front monitoring camera 110 is an imaging device for photographing the front of the vehicle. The raindrop detection camera 130 is an imaging device for photographing raindrops adhering to the windshield 200.

As shown in FIG. 1, the front monitoring camera 110 has an imager 111 and an output unit 112. The imager 111 is an imaging element that converts light incident through a lens into an electric signal. The imager 111 takes multiple images per second. The imager 111 outputs a video signal to the output unit 112 according to the D-PHY method of the MIPI (Mobile Industry Processor Interface) standard.

The output unit 112 is a serializer that serializes the video signal of the imager 111 in order to send the video signal input from the imager 111 to a single signal line 101. The signal line 101 transmits signals by, for example, LVDS (Low voltage differential signaling) communication.

The raindrop detection camera 130 has an imager 131, a humidity sensor 132 and an output unit 133. The imager 131 is an imaging element similar to the imager 111, and outputs a video signal to the output unit 133 by the D-PHY method.

The humidity sensor 132 is a sensor device that detects the humidity and the temperature of the passenger compartment of the vehicle. The humidity sensor 132 detects, as humidity, the relative humidity that indicates how much water vapor is included in the air at a certain temperature with respect to the maximum amount of water vapor that can be included in the air, that is, the amount of saturated water vapor. The temperature is the temperature near the windshield 200. The humidity sensor 132 outputs a detection signal including humidity information and temperature information to the output unit 133 by an I2C (Inter-Integrated Circuit) method.

The output unit 133, similar to the output unit 112, is a serializer that serializes the video signal of the imager 131 and the detection signal of the humidity sensor 132. The output unit 133 outputs the video signal and the detection signal to the output unit 112 of the front monitoring camera 110. Therefore, the video signal and the detection signal of the raindrop detection camera 130 are output to the electronic control unit 150 via the output unit 112 of the front monitoring camera 110.

Thus, the image data of the front image and the image data of the windshield image are output to the electronic control unit 150 via the common signal line 101. Information on humidity and temperature detected by the humidity sensor 132 is output to the electronic control unit 150 by being superimposed on the signal line 101. This eliminates the need for a dedicated signal line for the front monitoring camera 110 and a dedicated signal line for the raindrop detection camera 130, so connectors and wiring can be reduced.

The electronic control unit 150 is located at a distance from the windshield 200, the front monitoring camera 110 and the raindrop detection camera 130. The electronic control unit 150 has an input unit 151 and an image processing ECU (Electronic Control Unit) 152.

The input unit 151 is a deserializer connected to the output unit 112 of the front monitoring camera 110 via the signal line 101. The input unit 151 restores the serialized video signal or the serialized detection signal input via the signal line 101 to the original signal.

The image processing ECU 152 receives image data of a front image from the front monitoring camera 110 via the input unit 151 and performs image processing of the front image. The image processing ECU 152 also receives image data of the windshield image from the raindrop detection camera 130 via the input unit 151 and performs image processing of the windshield image.

Therefore, the image processing ECU 152 has a recognition unit 153, a raindrop control unit 154, a determination unit 155, a light calculation unit 156, a sun-light calculation unit 157 and a humidity calculation unit 158.

The recognition unit 153 receives the image data of the windshield image from the input unit 151 and recognizes raindrops adhering to the windshield 200 based on the image data of the windshield image. The recognition unit 153 has a DNN (Deep Neural Network) that has learned about the state of the windshield 200 such as raindrops and dirt. Therefore, the recognition unit 153 recognizes raindrops and dirt included in the windshield image using the learned DNN as a dictionary.

The raindrop control unit 154 determines a control of the wiper of the vehicle based on the recognition result of the recognition unit 153. That is, the raindrop control unit 154 determines the control of the wiper of the vehicle by detecting raindrops adhering to the windshield 200.

Here, the raindrop control unit 154 acquires information on the motor position of the wiper motor 400, information on the wiper SW 401 of the vehicle, and information on the vehicle speed from the body ECU 300. The raindrop control unit 154 determines on and off of the wiper and the operation mode of the wiper based on the recognition result of the recognition unit 153 and this information, and generates a wiping signal including wiper control details. The raindrop control unit 154 outputs a wiping signal to the body ECU 300 through CAN (Controller Area Network) communication.

Also, the raindrop control unit 154 determines a control of a washer that jets cleaning liquid to the windshield 200 by detecting the dirt on the windshield 200. The raindrop control unit 154 generates a wiping signal including washer control details.

The body ECU 300 is a device that controls various actuators mounted on the vehicle. The body ECU 300 acquires wiper setting information from the wiper SW 401 of the vehicle. The body ECU 300 acquires vehicle speed information from a meter ECU 500 that controls display of the vehicle speed through the CAN communication. The body ECU 300 acquires motor position information of the wiper motor 400 from the wiper ECU 402 that controls the wiper of the vehicle through LIN (Local Interconnect Network) communication.

The body ECU 300 also outputs a wiping signal input from the raindrop control unit 154 to the wiper ECU 402. The wiper ECU 402 controls driving of the wiper motor 400 according to the control content of the wiping signal. The raindrop control unit 154 may directly output the wiping signal to the wiper ECU 402 without passing through the body ECU 300.

The determination unit 155 performs image determination necessary for controlling the light of the vehicle and controlling the air conditioner. The determination unit 155 has a DNN that has already learned about the brightness around the vehicle, that is, the illuminance, and has a determination criteria for determining a tunnel and a bridge girder. Therefore, the determination unit 155 determines the illuminance around the vehicle, the tunnel, and the bridge girder included in the front image and the windshield image based on the DNN and other determination criteria. Either the front image or the windshield image may be used to determine the illuminance.

The light calculation unit 156 determines control of the light of the vehicle based on the determination result of the determination unit 155. That is, the light calculation unit 156 determines whether the light of the vehicle are turned on or off by detecting the illuminance around the vehicle.

The light calculation unit 156 generates a lighting signal including the content of light control. The light calculation unit 156 outputs a lighting signal to the body ECU 300 through the CAN communication. The body ECU 300 controls turning on/off of the light of the vehicle according to the control content of the lighting signal input from the light calculation unit 156.

The sun-light calculation unit 157 determines a control of the air conditioner of the vehicle based on the determination result of the determination unit 155. That is, the sun-light calculation unit 157 determines the control of the vehicle compartment air conditioning by detecting the intensity and the direction of the sun-light around the vehicle.

The sun-light calculation unit 157 generates a sun-light signal including details of the control of the air conditioner. Alternatively, the sun-light calculation unit 157 generates a sun-light signal that does not include air conditioner control details. The sun-light calculation unit 157 outputs a sun-light signal to the air conditioner ECU 600 through the CAN communication.

The air conditioner ECU 600 controls the air conditioner of the vehicle according to the control contents of the sun-light signal input from the sun-light calculation unit 157. Alternatively, the air conditioner ECU 600 may control the air conditioner of the vehicle using the sun-light signal.

The humidity calculation unit 158 obtains the humidity and the temperature of the vehicle compartment by calculation based on the detection signal input from the input unit 151. Here, the humidity calculation unit 158 acquires information on the windshield temperature of the windshield 200 from the outside air temperature sensor 700 mounted on the vehicle. The humidity calculation unit 158 generates a humidity signal including humidity and temperature information based on the detection signal and the windshield temperature, and outputs the humidity signal to the air conditioner ECU 600 by the CAN communication.

Also, the humidity calculation unit 158 determines a control of a heater for warming the front side of the front monitoring camera 110 and the raindrop detection camera 130 based on the detection signal. The heater is arranged in the windshield 200. Alternatively, the heater may be arranged in a black ceramic portion. Specifically, in order not to block the view from the front monitoring camera 110 and the raindrop detection camera 130, the black ceramic portion has a defect portion having a trapezoidal shape corresponding to the view angle range of the front monitoring camera 110 and the raindrop detection camera 130. The heater is then placed in the defect portion of the black ceramic portion.

Further, the humidity calculation unit 158 determines control of a defroster that blows air toward the windshield 200 based on the detection signal. The humidity calculation unit 158 outputs a humidity signal including defroster control details to the air conditioner ECU 600.

The electronic control unit 150 performs control to assist the user's driving operation. Therefore, the electronic control unit 150 detects the situation around the vehicle by performing the image processing of the front image by the image processing ECU 152. The electronic control unit 150 receives information from sensors such as a vehicle speed sensor, a steering sensor, and an accelerator sensor. The electronic control unit 150 may acquire the information of each sensor from the body ECU 300 or directly from each sensor. The electronic control unit 150 acquires date and time information and vehicle position information such as latitude/longitude and orientation from the navigation ECU 800 for executing navigation to a destination, and uses the acquired information for vehicle control.

The electronic control unit 150 grasps the driving conditions of the vehicle based on the result of the image processing and the information of each sensor, and executes the control of the vehicle to prevent or reduce the collision of the vehicle with surrounding objects. For example, when the electronic control unit 150 determines that it is necessary to operate the brake or the steering to avoid or reduce contact with an object in front of the vehicle, the electronic control unit 150 outputs a sudden steering warning signal or a sudden braking warning signal to the body ECU 300. The body ECU 300 informs the user of the vehicle about the surrounding conditions of the vehicle and controls the operation of the vehicle based on each signal of the electronic control unit 150.

The navigation ECU 800 is configured to be able to communicate with a cloud server 900. Thereby, the navigation ECU 800 can acquire information such as traffic conditions. The electronic control unit 150 may acquire information necessary for driving assistance by communicating directly with the cloud server 900.

As described above, in this embodiment, the front monitoring camera 110 and the raindrop detection camera 130 are arranged on the windshield 200. According to this, the electronic control unit 150 is located at a distance from the windshield 200, the front monitoring camera 110 and the raindrop detection camera 130. Therefore, the front monitoring camera 110 and the raindrop detection camera 130 need only be arranged on the windshield 200, so no space is required for arranging the electronic control unit 150. Therefore, it is possible to reduce the size of the casing arranged on the windshield 200.

### Second Embodiment

In the present embodiment, portions different from those of the first embodiment will be mainly described. As shown in FIG. 3, the front monitoring camera 110 has a front casing 113.

The front casing 113 is fixed to the windshield 200. The front casing 113 is made of resin or metal. The front casing 113 may be made of a composite material such as a resin material and a metal material. The front casing 113 has a base unit 114 and a camera unit 115. The base unit 114 accommodates a circuit board and the like.

The camera unit 115 is integrated with the base unit 114 and accommodates the imager 111 and the lens unit 116. The camera unit 115 has one through-hole 117 through which the lens unit 116 is accommodated. The camera unit 115 is positioned above the base unit 114 and on one side surface 118 of the base unit 114. Thereby, a space portion is formed on the other side surface 119 of the upper portion of the base unit 114. The lens unit 116 is a lens module focused to infinity.

On the other hand, the raindrop detection camera 130 has a raindrop casing 134 separate from the front casing 113. The raindrop casing 134 is smaller in size than the front casing 113. The raindrop casing 134 is made of resin or metal. The raindrop casing 134 may be made of a composite material such as a resin material and a metal material.

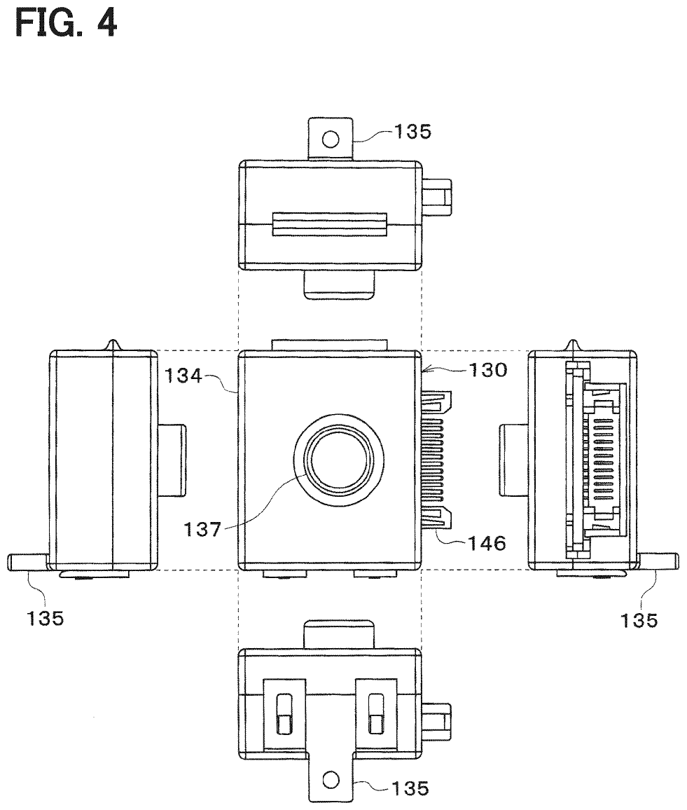

As shown in FIG. 4, the raindrop casing 134 has a fixing unit 135. The fixing unit 135 is a projecting portion for fixing the raindrop casing 134 of the raindrop detection camera 130 to the front casing 113 of the front monitoring camera 110. The fixing unit 135 is fixed to the front casing 113 with screws, for example.

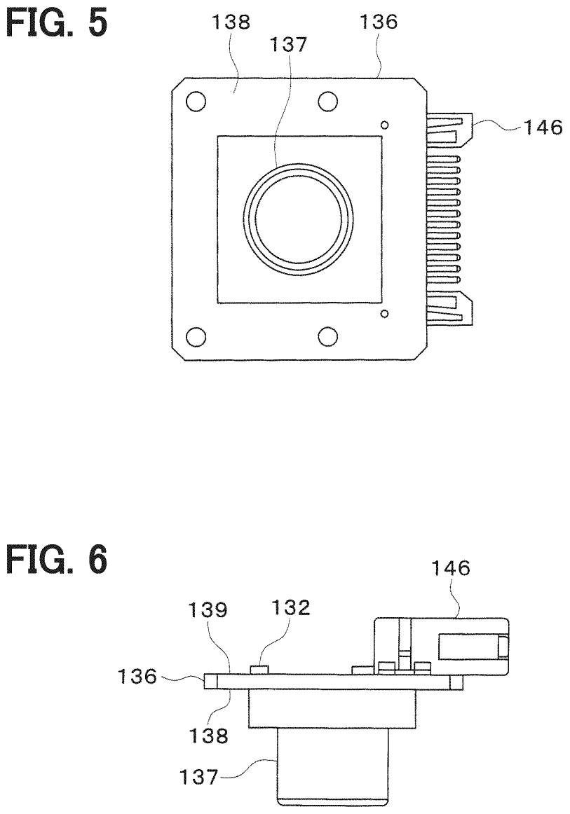

Also, as shown in FIGS. 3 to 8, the raindrop detection camera 130 has a circuit board 136, a lens unit 137, and a humidity sensor 132. As shown in FIG. 6, the circuit board 136 is a printed circuit board having a front side 138 and a back side 139. The imager 131 and the lens unit 137 are mounted on the surface 138 of the circuit board 136. The humidity sensor 132 is mounted on the back surface 139 of the circuit board 136. Here, the humidity sensor 132 may be mounted on the surface 138 of the circuit board 136.

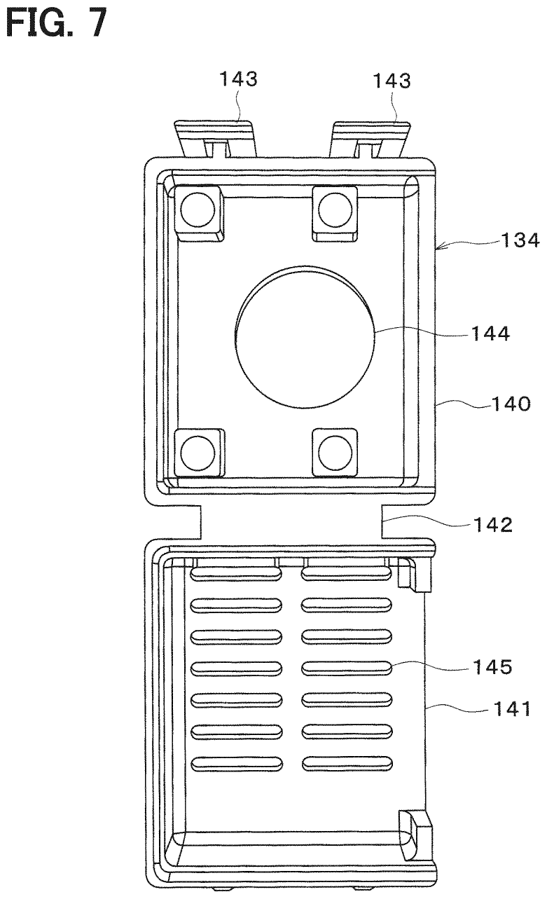

As shown in FIG. 7, the raindrop casing 134 has two container units 140 and 141 connected by a connecting unit 142, and the connecting unit 142 is foldable. The raindrop casing 134 accommodates the circuit board 136 and the like inside by bending the connection unit 142 and fixing the respective container units 140 and 141 with a snap fit 143.

One container unit 140 has one through hole 144 for accommodating the lens unit 137 therethrough. the one container unit 140 and the other container unit 141 have a plurality of through holes 145 that connect the inside and the outside of the raindrop casing 134. As a result, the humidity sensor 132 can measure the humidity in the vicinity of the windshield 200 without being disturbed by the heat generated by the electronic components mounted on the circuit board 136. The circuit board 136 is fixed to the other container unit 141 by screwing.

As shown in FIG. 3, the front monitoring camera 110 and the raindrop detection camera 130 are electrically connected by a board-to-board connector 120. In the board-to-board connector 120, the connector 121 on one side and the connector 146 on the other side are assembled to integrate and electrically connect the connectors 121 on the one side and the connector 146 on the other side. Here, FIG. 3 shows a state in which the front monitoring camera 110 and the raindrop detection camera 130 are separated.

The front monitoring camera 110 has the one connector 121. The one connector 121 is provided on the other side surface 119 side of the base unit 114 of the camera unit 115 of the front casing 113. That is, the one connector 121 protrudes from the camera unit 115 toward the other side surface 119 of the base unit 114.

The raindrop detection camera 130 has the other connector 146. The other connector 146 is mounted on the back surface 139 of the circuit board 136, as shown in FIG. 6. Also, as shown in FIG. 4, the other connector 146 protrudes from the raindrop casing 134.

As shown in FIG. 3, the raindrop casing 134 is arranged next to the camera unit 115 of the front casing 113, and the other connector 146 of the raindrop detection camera 130 is assembled to the one connector 121 of the front monitoring camera 110. Accordingly, the raindrop detection camera 130 is supplied with electric power from the front monitoring camera 110, and can output a video signal and a humidity signal.

In this embodiment, the raindrop detection camera 130 is detachable from the front monitoring camera 110. That is, the raindrop detection camera 130 is attachable to the front monitoring camera 110 by means of the board-to-board connector 120. Moreover, the raindrop detection camera 130 can be attached to and detached from the front casing 113 of the front monitoring camera 110 by the fixing unit 135 of the raindrop casing 134. For example, if the raindrop detection camera 130 malfunctions, the raindrop detection camera 130 can be replaced. Alternatively, the raindrop detection camera 130 can be removed from the front monitoring camera 110 when the raindrop detection camera 130 is not necessary.

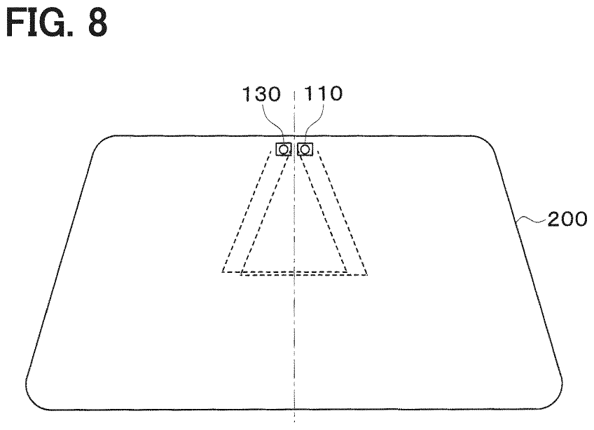

Further, as shown in FIG. 8, a part of the view angle of the front monitoring camera 110 and a part of the view angle of the raindrop detection camera 130 overlap. In other words, the view angle of the front monitoring camera 110 and the view angle of the raindrop detection camera 130 share a part. As a result, one of the front image of the front monitoring camera 110 and the windshield image of the raindrop detection camera 130 can be substituted for the other.

In the above configuration, the humidity calculation unit 158 of the electronic control unit 150 acquires information on the humidity and the temperature of the vehicle compartment from the humidity sensor 132 and acquires information on the outside temperature around the vehicle from the outside temperature sensor 700. Then, the humidity calculation unit 158 estimates the humidity of the windshield surface of the windshield 200 using each information of the humidity and the temperature of the vehicle compartment and the outside air temperature around the vehicle.

The humidity calculation unit 158 outputs a humidity signal including the humidity of the windshield surface of the windshield 200 to the air conditioner ECU 600. The air conditioner ECU 600 uses information on the humidity of the windshield surface to control the defroster, for example.

As described above, by integrating the raindrop detection camera 130 and the humidity sensor 132, highly accurate raindrop detection and humidity detection can be achieved with a compact configuration. Moreover, since the raindrop detection camera 130 is electrically connected to the front monitoring camera 110 by the board-to-board connector 120, there is no need to prepare the raindrop casing 134 corresponding to the inclination angle of the windshield 200. Therefore, the number of variations of the raindrop casing 134 can be reduced.

As a modification, a part of the view angle of the front monitoring camera 110 and a part of the view angle of the raindrop detection camera 130 may not overlap. For example, the photographing direction of the raindrop detection camera 130 may be set higher than the photographing direction of the front monitoring camera 110.

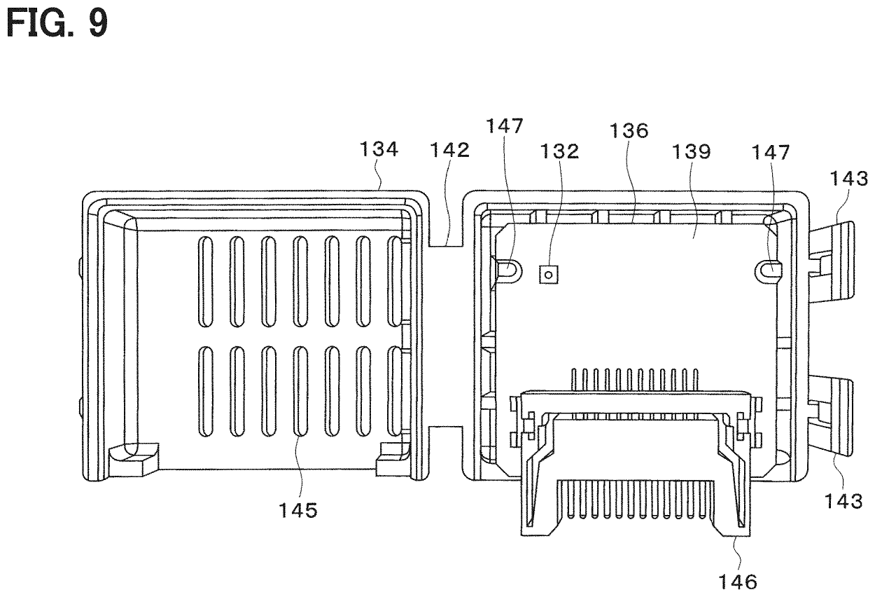

Alternatively, as shown in FIG. 9, the circuit board 136 may be assembled to the raindrop casing 134 by hooking onto a snap fit 147 provided inside the container unit 140. Alternatively, the circuit board 136 may be assembled to the raindrop casing 134 by being press-fitted inside the container unit 140 or by heat crimping inside the container unit 140.

### Third Embodiment

In the present embodiment, the configurations different from the respective embodiments described above will be described. In this embodiment, the raindrop detection camera 130 has a depth of field corresponding to the inclination angle of the windshield 200. The depth of field is the in-focus range within the photographing range.

In order to obtain the depth of field corresponding to the inclination angle of the windshield 200, the lens unit 137 of the raindrop detection camera 130 is designed to have a small f-number. That is, the lens unit 137 has a wide-angle lens.

Here, the optical axis of the lens unit 137 of the raindrop detection camera 130 is inclined toward the ceiling so that the windshield surface of the windshield 200 can be easily focused based on the Scheimpflug principle. This makes it possible to photograph a wider range of the windshield 200.

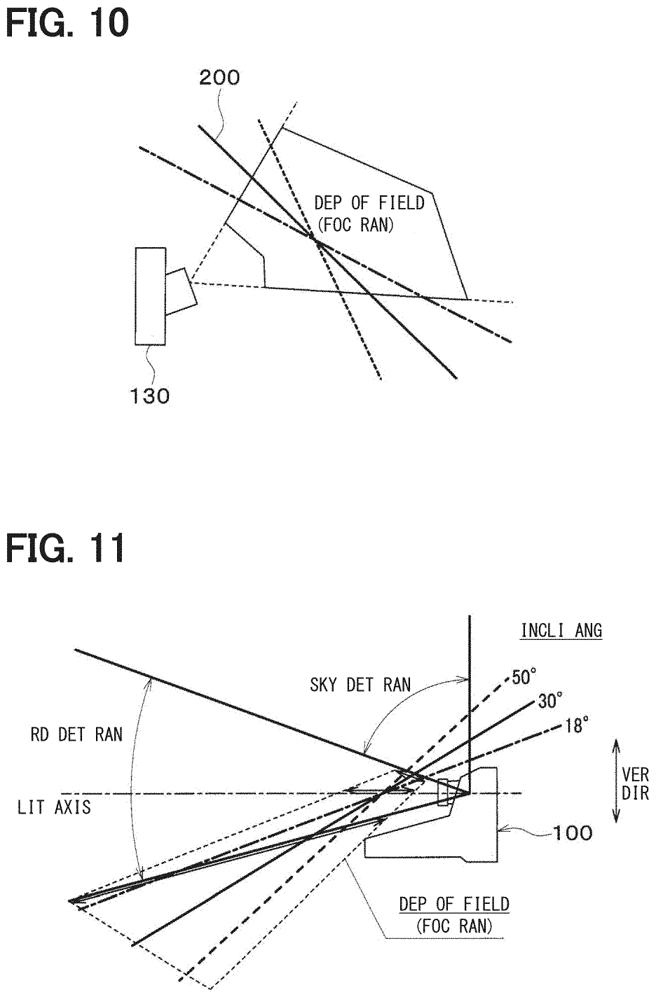

Therefore, as shown in FIG. 10, the depth of field is widened even if the inclination angle of the windshield 200 differs from vehicle to vehicle. That is, a wide range is focused. Therefore, various inclination angles of the windshield 200 can be adapted. In other words, it is not necessary to design the raindrop detection camera 130 for each vehicle. Variations of the raindrop detection camera 130 can be reduced.

### Fourth Embodiment

In the present embodiment, portions different from those of the third embodiment will be mainly described. As shown in FIG. 11, the raindrop detection camera 130 photographs raindrops adhering to the windshield 200 in the ground side range of the view angle in the vertical direction. The view angle corresponding to the raindrop detection range in the vertical direction is, for example, 30 degrees.

The raindrop detection range is a range including the optical axis of the raindrop detection camera 130 in the windshield image. The depth of field, which is the focus range of the raindrop detection camera 130, is set on the ground side. As a result, the range of depth of field on the windshield surface of the windshield 200 becomes wider than the range of depth of field on the optical axis. The raindrop detection range is used to recognize raindrops.

In addition, the raindrop detection camera 130 photographs the surroundings of the vehicle in the ceiling side range of the view angle in the vertical direction. The view angle corresponding to the sky detection range in the vertical direction is, for example, 30 degrees to 90 degrees. The sky detection range is a range that includes the sky. The sky detection range is used to determine the illuminance around the vehicle. Here, FIG. 11 shows a case where the inclination angle of the windshield 200 is from 18 degrees to 50 degrees.

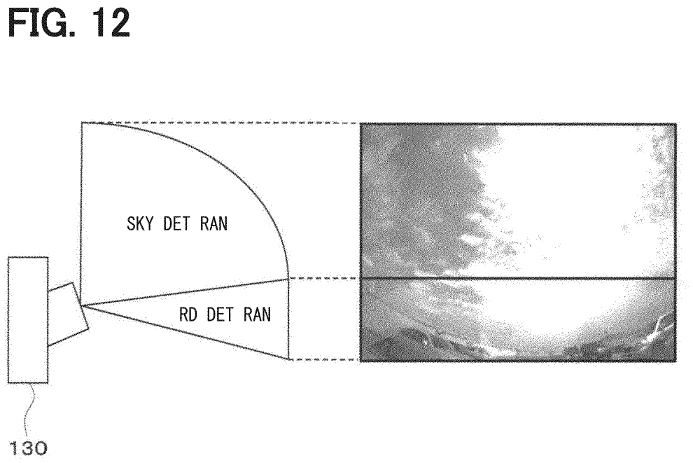

Therefore, as shown in FIG. 12, in one windshield image, the sky detection range is photographed on the upper side of the windshield image, and the raindrop detection range is photographed on the lower side of the windshield image. Accordingly, not only the raindrops on the windshield 200 but also the situation above the vehicle may be photographed by the single raindrop detection camera 130.

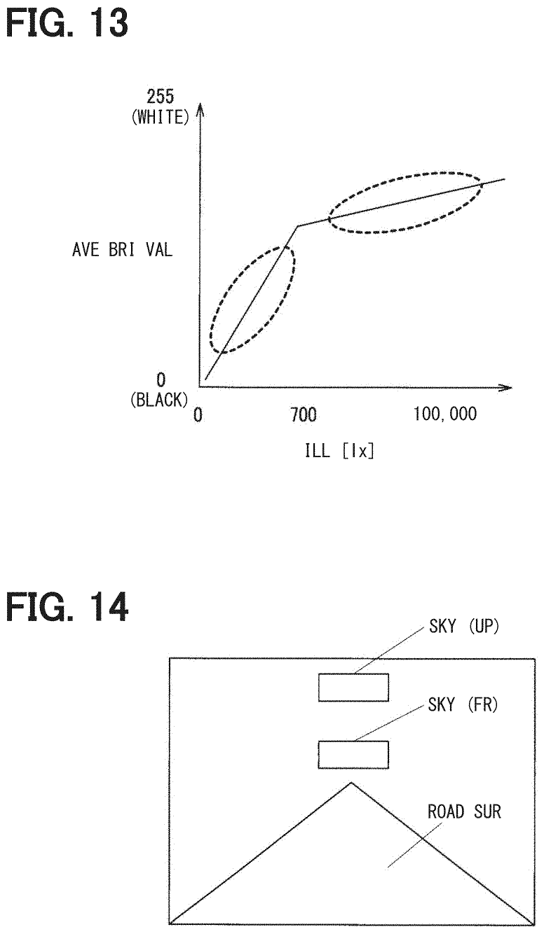

The electronic control unit 150 implements functions as a light sensor and a sun-light sensor. Specifically, the light calculation unit 156 of the image processing ECU 152 estimates the illuminance of the front light of the vehicle from the average brightness value of pixels corresponding to the horizontal direction based on the windshield image input via the determination unit 155. As shown in FIG. 13, the illuminance of the light ahead of the vehicle can be estimated from the relationship between the average brightness value and the illuminance. When the illuminance rises to some extent, the difference in the average brightness value becomes small.

Further, as shown in FIG. 14, the sky area above the vehicle and the sky area in front of the vehicle are photographed in the windshield image. Therefore, the light calculation unit 156 estimates the illuminance of the upper light from the average brightness value of the upper sky region in the windshield image.

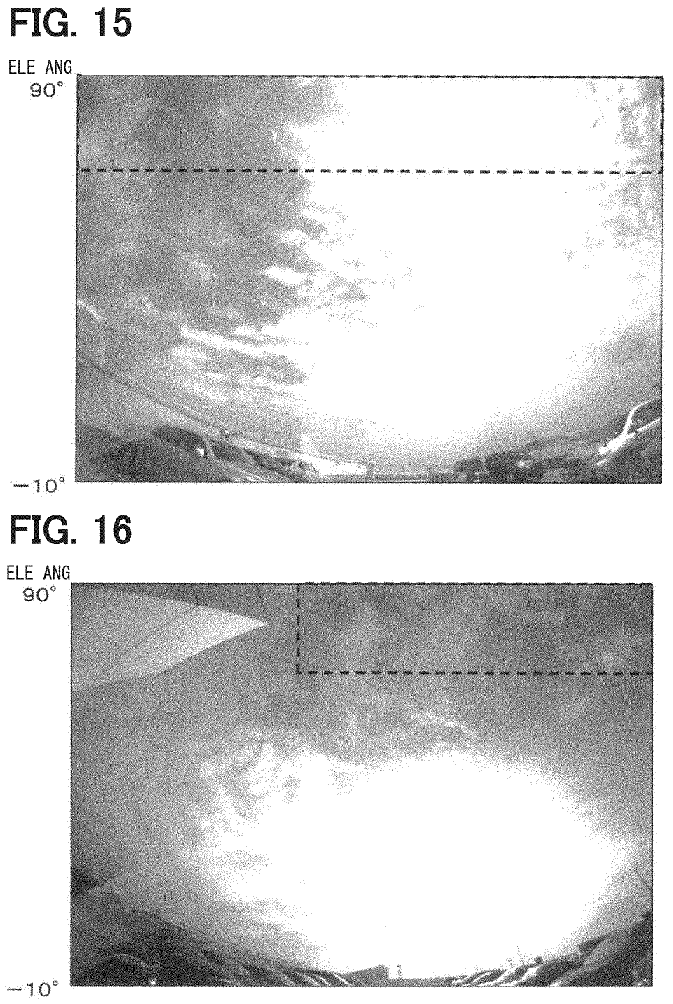

The light calculation unit 156 determines control of the vehicle light based on the illuminance estimated from the windshield image. For example, as shown in FIG. 15, it is determined to turn off the light when the illuminance in the area surrounded by the dashed line is, for example, 100,000 lux.

Alternatively, as shown in FIG. 16, it is determined to turn off the light when the illuminance in the range surrounded by the dashed line is, for example, 50,000 lux. Alternatively, as shown in FIG. 17, it is determined to turn on the light when the illuminance in the area surrounded by the dashed line is 300 lux. The light calculation unit 156 outputs a light signal including control details for turning on/off the light to the body ECU 300.

The sun-light calculation unit 157 estimates the direction angle from the peak of the brightness value in the horizontal direction of the sky detection range corresponding to the sky area in the windshield image input via the determination unit 155. In addition, the sun-light calculation unit 157 acquires GPS information or information on the latitude, longitude, date and time, and a driving direction of the vehicle from the navigation ECU 800, and estimates the sun angle. The sun angle is the elevation angle of the sun. Further, the sun-light calculation unit 157 determines shade or sunshine from the average brightness value of the windshield image.

The sun-light calculation unit 157 determines control of the air conditioner of the vehicle based on the sun-light information estimated from the windshield image. The sun-light calculation unit 157 outputs a sun-light signal including details of control of the air conditioner to the air conditioner ECU 600. Alternatively, the sun-light calculation unit 157 outputs a sun-light signal including the sun-light information estimated from the windshield image to the air conditioner ECU 600.

As described above, based on the windshield image captured by the raindrop detection camera 130, the electronic control unit 150 can realize the functions of the light sensor and the sunlight sensor. Here, the light calculation unit 156 and the sun-light calculation unit 157 may estimate the illuminance using the front image of the front monitoring camera 110.

As a modification, the light calculation unit 156 and the sun-light calculation unit 157 may calculate the brightness value of the windshield image from the auto gain parameter, the auto exposure parameter, and pixel values. The brightness value is calculated by an equation of “(brightness value)=(pixel value)/(exposure time)/(gain)”. A pixel value is a numerical value from 0 to 255. Thus, the exposure and gain values allow the determination of the brightness value.

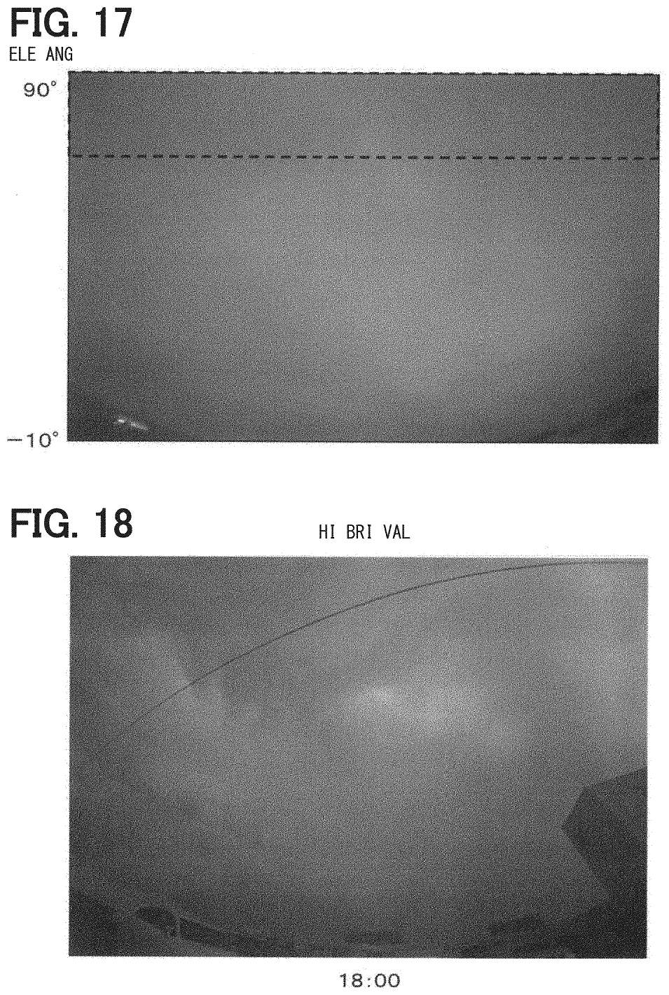

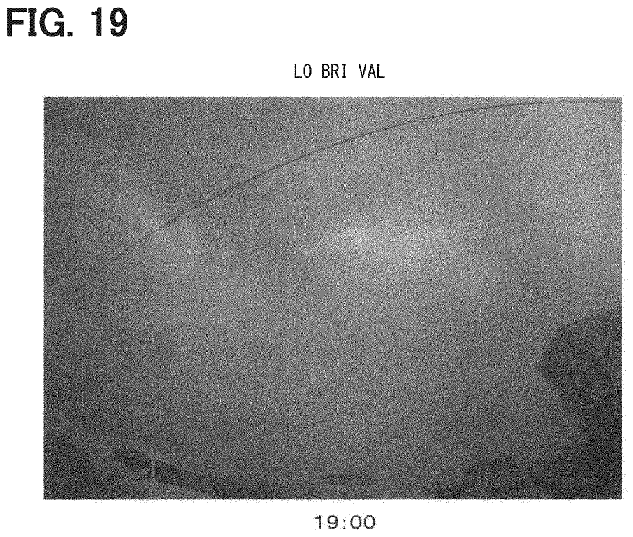

For example, as shown in FIG. 18, the brightness value of the windshield image is high at 18:00. On the other hand, as shown in FIG. 19, since the brightness value of the windshield image is low at 19:00, the windshield image should look dark in general. However, the automatic adjustment of the image may make dark situations appear brighter. Even if the difference due to appearance becomes small in this way, the brightness value corresponding to the original brightness can be obtained by the above calculation.

### Fifth Embodiment

In the present embodiment, portions different from those of the third embodiment will be mainly described. In this embodiment, the raindrop detection camera 130 changes the magnification of the raindrop detection range in the vertical direction and the magnification of other ranges in the windshield image. As a result, the raindrop detection camera 130 makes the detection range of raindrops in the windshield image relatively wider than the other ranges.

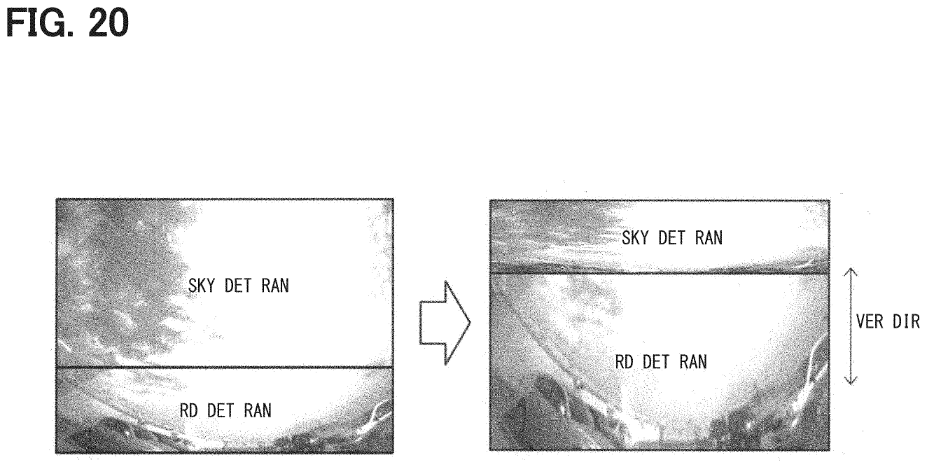

Specifically, as shown on the left side of FIG. 20, the sky detection range of the windshield image is photographed as a wider range than the raindrop detection range in the vertical direction. The sky detection range may not always be wide, as long as the illuminance around the vehicle can be estimated. On the other hand, the wider the raindrop detection range, the better, in order to ensure the raindrop detection capability.

Therefore, as shown on the right side of FIG. 20, the raindrop detection camera 130 makes the magnification of the sky detection range in the vertical direction smaller than the magnification of the raindrop detection range. As a result, the raindrop detection range is relatively wider than the sky detection range in the vertical direction.

As described above, by changing the magnification of a specific range in the windshield image, it is possible to detect the illuminance and raindrops around the vehicle from one windshield image with high accuracy. Here, the rain control unit 154 may change the magnification of a specific range in the windshield image.

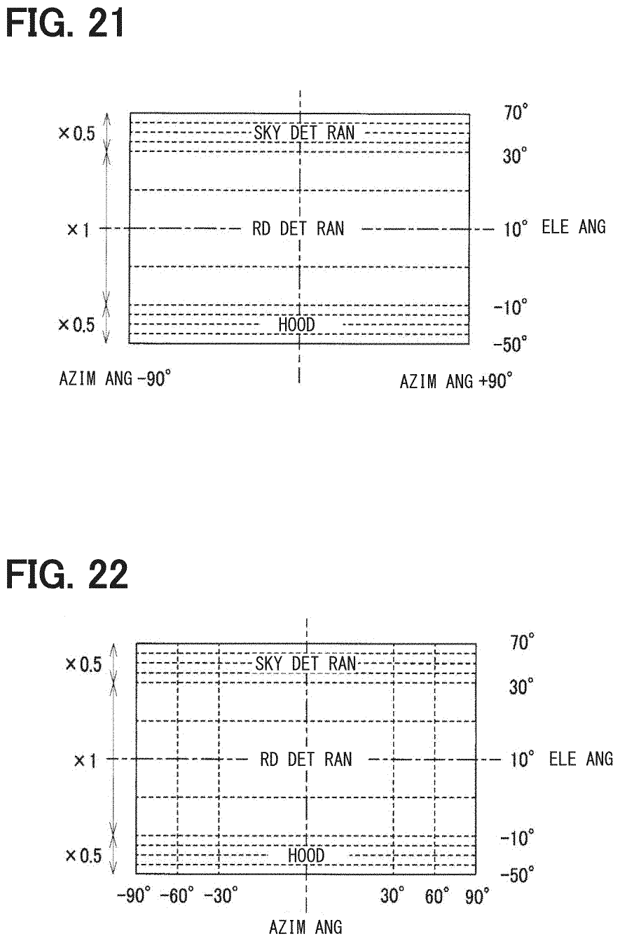

As a modification, as shown in FIG. 21, when the hood of the vehicle is photographed on the lower side of the windshield image, the raindrop detection camera 130 reduces not only the magnification of the sky detection range but also the magnification of the hood range to be smaller than the magnification of the raindrop detection range in the elevation angle direction of the windshield image. For example, the magnification of the sky detection range and the hood range is set to 0.5. The direction of the elevation angle corresponds to the vertical direction of the vehicle. This makes it possible to relatively reduce the hood range that is unnecessary for detecting the illuminance and raindrops around the vehicle.

As a modification, as shown in FIG. 22, the magnification near zero degree is made higher than the magnification near ±90 degrees not only in the elevation angle direction of the windshield image but also in the azimuth direction. The direction of the azimuth angle corresponds to the right-left direction of the vehicle. In this manner, the magnification of the windshield image in two directions may be changed. Here, FIG. 22 is actually a circular image.

### Sixth Embodiment

In the present embodiment, the configurations different from the respective embodiments described above will be described. In this embodiment, the electronic control unit 150 acquires the raindrop adhesion rate, estimates the amount of rainfall based on the raindrop adhesion rate, and determines control of the wiper of the vehicle according to the rainfall amount.

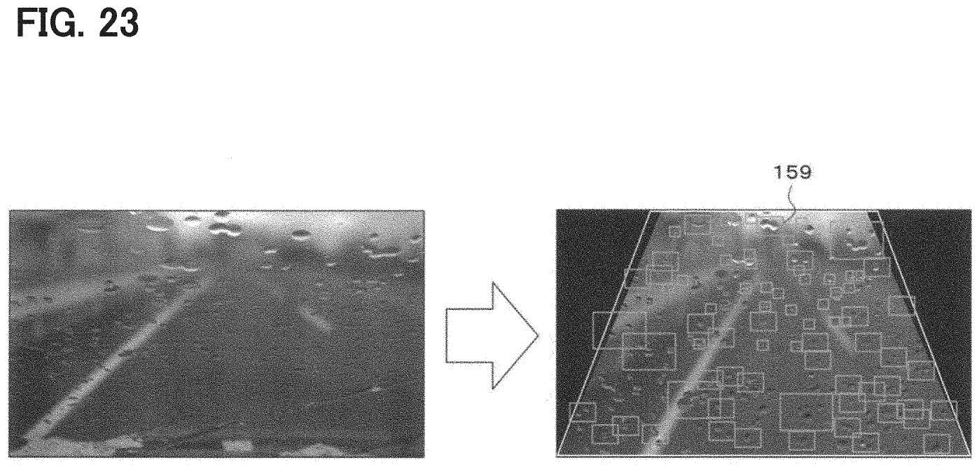

Therefore, the electronic control unit 150 recognizes raindrops included in the windshield image based on the windshield image in the recognition unit 153. Specifically, as shown in FIG. 23, the recognition unit 153 recognizes raindrops included in the windshield image and surrounds the recognized raindrops with a frame 159. When the frames 159 overlap, the recognition unit 153 adopts the frame 159 with high reliability as a raindrop. Here, the recognition unit 153 may give a frame 159 to each raindrop so that the frames 159 do not overlap.

Then, the raindrop control unit 154 acquires the raindrop adhesion rate by comparing the total area of the windshield image and the total area of the raindrops included in the windshield image. That is, the raindrop control unit 154 calculates an equation of “(raindrop adhesion rate [%])=(total area of raindrops)/(total area of windshield image)×100. The total raindrop area is the total area of all the frames 159.

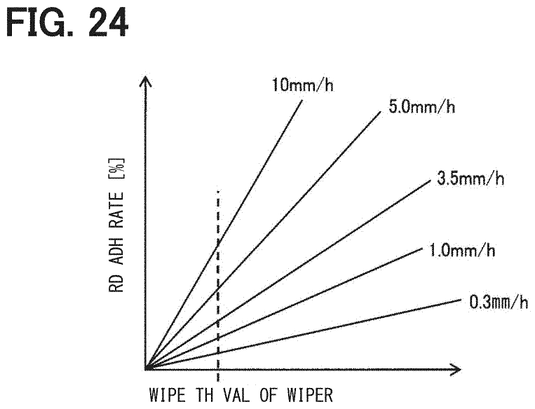

Also, the raindrop control unit 154 determines the wiping speed of the wiper in order to control the wiper corresponding to the raindrop adhesion rate. As shown in FIG. 24, the wiper wiping threshold is set with respect to the raindrop adhesion rate, and the wiping speed of the wiper is determined with respect to the raindrop adhesion rate exceeding the wiper wiping threshold. In other words, the amount of rainfall is estimated based on the raindrop adhesion rate, and the wiping speed of the wiper corresponding to the amount of rainfall is selected. The higher the raindrop adhesion rate, the faster the wiping speed of the wiper.

The raindrop control unit 154 outputs a wiping signal including the wiping speed of the wiper to the body ECU 300. As described above, the wiper of the vehicle can be controlled based on the raindrop adhesion rate.

### Seventh Embodiment

In the present embodiment, portions different from those of the sixth embodiment will be mainly described. In this embodiment, the electronic control unit 150 determines splashes or raindrops on the windshield 200 based on the windshield image, and determines the control of the wiper of the vehicle based on the determination result.

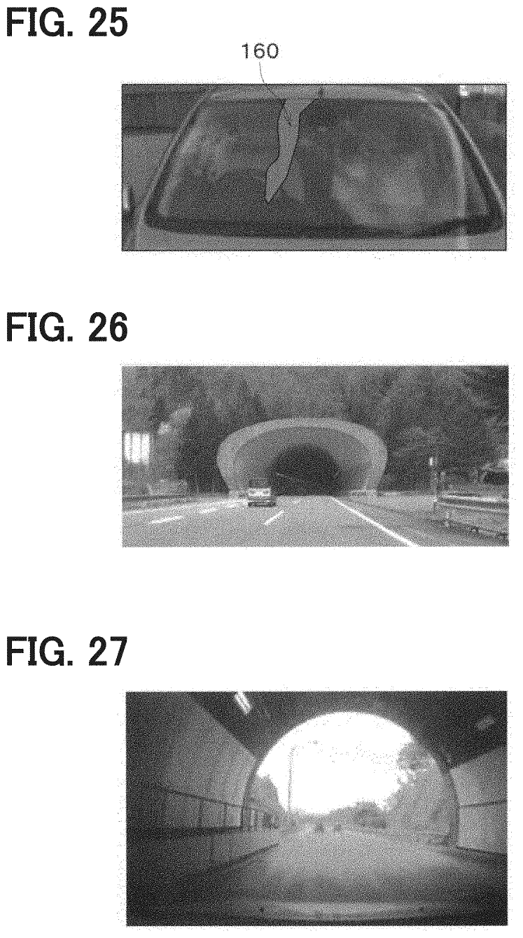

The spray is water that splashes toward the vehicle when another vehicle steps on a puddle. As shown in FIG. 25, the raindrops 160 are water that flows from the roof of the vehicle onto the windshield 200. For example, the recognition unit 153 Fourier-transforms the windshield image, extracts the feature amount of the frequency, and recognizes the splashes and the raindrops 160 based on the feature amount. The raindrop control unit 154 determines a wiper operation mode according to the spray or the raindrops 160 and outputs a wiping signal to the body ECU 300 In this way, by determining wiper control according to the situation, it is possible to satisfy the user's wiping request.

In addition to the splashes and the raindrops 160, the image processing using the Fourier transform can also recognize ripples of raindrops, mud, wetness of the windshield 200, backlight, scratches on the windshield 200, and the like.

In addition, while the wiper of the vehicle are operating, the electronic control unit 150 determines whether the vehicle is entering or exiting the tunnel based on the front image, and determines control of the wiper at the entrance and exit of the tunnel based on the determination result. In this case, the raindrop control unit 154 receives the tunnel determination result from the determination unit 155 and determines whether the vehicle enters or exits the tunnel based on the front image.

Then, as shown in FIG. 26, when the vehicle enters a tunnel, the raindrop control unit 154 determines the control to stop the wiper of the vehicle immediately after entering the tunnel. On the other hand, when the vehicle exits the tunnel as shown in FIG. 27, the raindrop control unit 154 determines the control to make the wiping speed of the wiper of the vehicle faster than the previously set wiping speed immediately after exiting the tunnel.

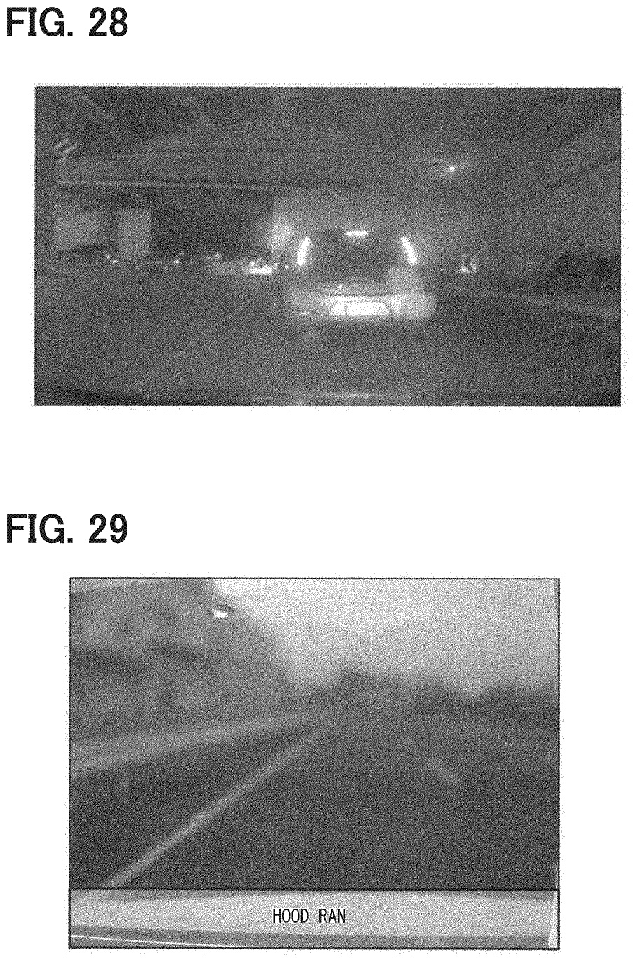

As shown in FIG. 28, the raindrop control unit 154 may determine to control the wiper at the entrance/exit of the bridge girder in the same manner as described above.

Therefore, at the entrance of a tunnel or a bridge girder, the operation of the wiper of the vehicle can be quickly stopped. Since the empty wiping of the wiper does not continue, it is possible to make it difficult for the user to feel annoyed. In addition, at the exit of a tunnel or a bridge girder, the windshield wiper of the vehicle can be operated quickly to immediately respond to the rainy conditions.

### Eighth Embodiment

In the present embodiment, portions different from those of the sixth and seventh embodiments will be mainly described. In this embodiment, the electronic control unit 150 determines the operating speed of the wiper of the vehicle according to the water-repellent state of the windshield 200.

Therefore, the recognition unit 153 recognizes the size and the number of raindrops included in the windshield image. Here, the shape of raindrops may be recognized. The raindrop control unit 154 detects the water-repellent state of the windshield 200 based on the size and the number of raindrops. When the raindrops are small, it can be determined that the water repellency is good. For example, the raindrop control unit 154 has a water repellent state map corresponding to the size and the number of raindrops. The raindrop control unit 154 determines the water repellency state based on the map.

When the raindrop control unit 154 determines that the diameter of the raindrops is small and the number of raindrops is large, the raindrop control unit 154 determines to control the wiping speed of the wiper to be slower than normal, estimating that the windshield 200 is made of water-repellent glass. In this manner, the operating speed of the wiper can be changed according to the water-repellent state of the windshield 200.

### Ninth Embodiment

In the present embodiment, portions different from those of the sixth to eighth embodiments will be mainly described. In this embodiment, the electronic control unit 150 determines the brightness around the vehicle based on the front image or the windshield image, and determines the control of turning on/off the light of the vehicle based on the determination result of the brightness.

The determination unit 155 determines the brightness around the vehicle based on the brightness, exposure time, and gain of the front image or the windshield image. The brightness is illuminance. The light calculation unit 156 has a turning-on threshold and a turning-off threshold for illuminance. The light calculation unit 156 determines control to turn on the light of the vehicle when the illuminance is smaller than the turning-on threshold. Also, it determines the control to turn off the light of the vehicle when the illuminance is greater than the turn-off threshold.

Here, the luminance of an object may differ depending on the color of the object even if the illuminance is the same. Therefore, the front monitoring camera 110 is arranged on the windshield 200 so that a part of the vehicle such as the hood and dashboard is always photographed in the front image of the front monitoring camera 110. For example, as shown in FIG. 29, the hood area is always photographed in the lower area of the front image.

The light calculation unit 156 acquires information on the color of the vehicle body from the body ECU 300 and also acquires the brightness of the hood range of the front image. Then, the light calculation unit 156 acquires the illuminance corrected for the influence of the color from the information on the color of the vehicle body and the brightness of the hood area. The light calculation unit 156 determines control of turning on/off the light of the vehicle by comparing the turning-on threshold value and the turning off threshold value with the acquired illuminance.

Therefore, the illuminance around the vehicle can be obtained from the front image without performing image processing for specifying the subject and the color of the subject included in the front image. Also, processing resources can be reduced by reducing the image processing load. It is also possible to improve the added value by allocating resources to the function expansion of the image processing ECU 152.

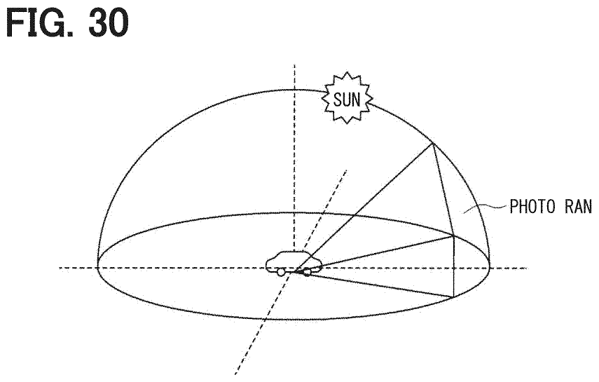

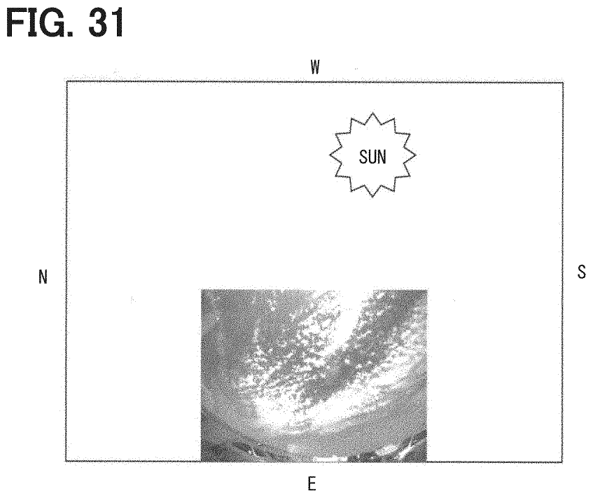

As a modification, as shown in FIGS. 30 and 31, when the vehicle is traveling east and the sun is not photographed in the front image, the sun-light calculation unit 157 may estimate the position of the sun. The sun-light calculation unit 157 obtains GPS information including latitude, longitude, date and time, information on the view angle of the image of the front monitoring camera 110, and a front image, and estimates the position of the sun based on these information.

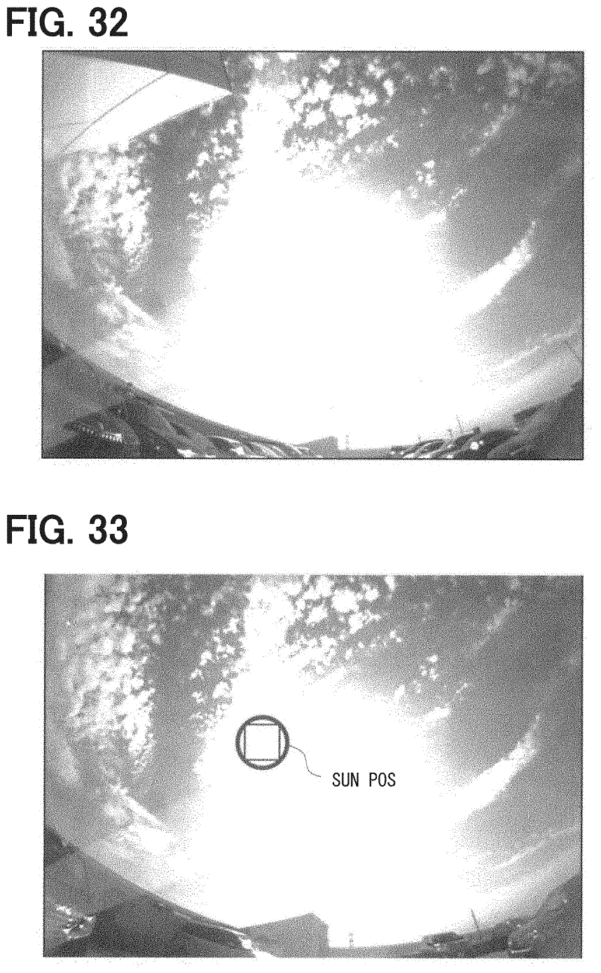

As shown in FIG. 32, even if the sun is included in the front image, the front image may be overexposed and the position of the sun may not be known. Even in such a case, the position of the sun in the front image can be estimated, as shown in FIG. 33.

Therefore, the sun-light calculation unit 157 can acquire the direction and the intensity of the sun-light even if the sun is not included in the front image. It also eliminates the need for a fisheye lens and high dynamic range synthesis processing for photographing the sun.

### Tenth Embodiment

In the present embodiment, the configurations different from the respective embodiments described above will be described. In this embodiment, the electronic control unit 150 grasps the weather conditions around the vehicle based on the front image or the windshield image, and transmits the position information of the vehicle and the weather conditions to the cloud server 900.

The front image of the front monitoring camera 110 or the windshield image of the raindrop detection camera 130 includes road surface information such as sunny, cloudy, rainy, snowy, frozen, and dirt on the road. Therefore, the recognition unit 153 of the image processing ECU 152 identifies road conditions from the front image or the windshield image. In other words, the vehicle provides a probe car that determines road conditions.

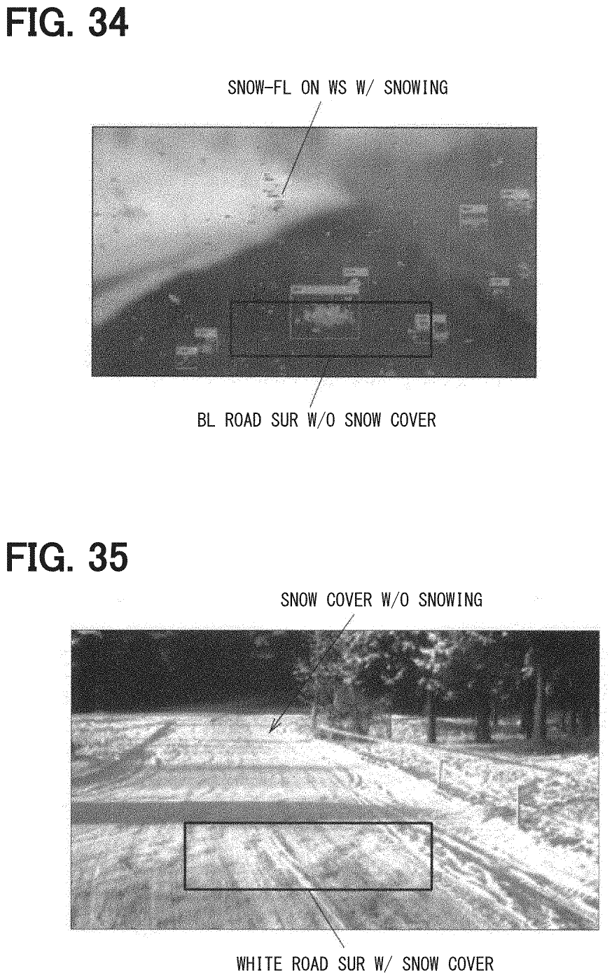

For example, as shown in FIG. 34, the recognition unit 153 recognizes snow adhering to the windshield surface of the windshield 200 or a black road surface. Thereby, the image processing ECU 152 can detect that the snow is falling but the snow does not cover the road. Alternatively, as shown in FIG. 35, the recognition unit 153 recognizes that nothing is attached to the windshield 200 or that the road surface is white. Thereby, the image processing ECU 152 can detect that the snow is not falling but the snow covers the road.

The electronic control unit 150 transmits vehicle position information and weather conditions to the cloud server 900 via the navigation ECU 800. The cloud server 900 can utilize vehicle position information and weather conditions for a road condition distribution service.

The electronic control unit 150 also uses the detected weather conditions for controlling the subject vehicle. That is, the image processing ECU 152 changes the vehicle control method according to the detected snowfall and snow cover conditions. For example, the humidity calculation unit 158 detects a freezing state of the windshield 200 and causes the air conditioner ECU 600 to operate a defroster. Alternatively, the image processing ECU 152 detects snow covering the road surface and performs control to suppress sudden braking of the vehicle.

As described above, by recognizing the weather conditions around the vehicle from the front image or the windshield image, the recognition result can be used to control the subject vehicle and other vehicles.

### Eleventh Embodiment

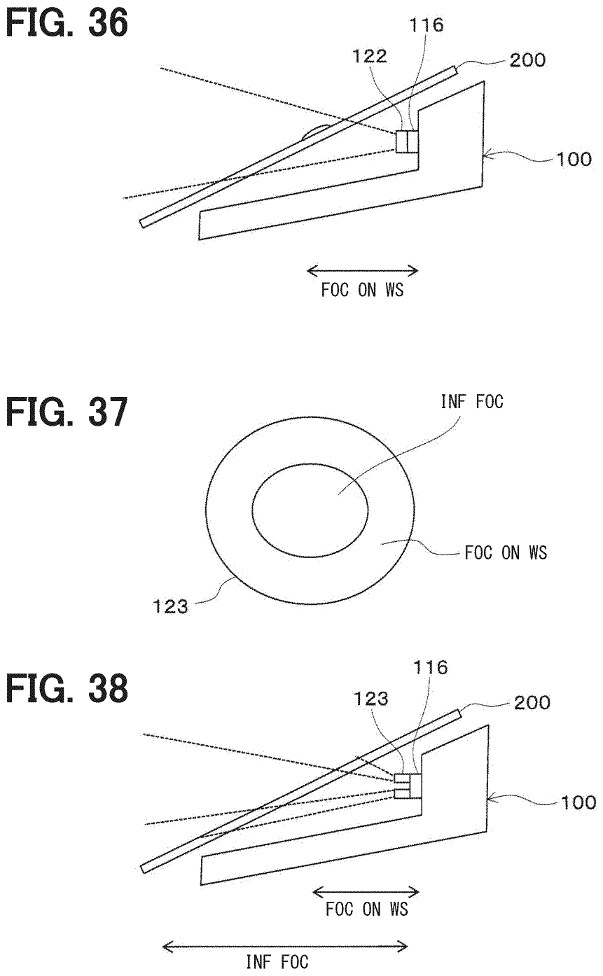

In the present embodiment, the configurations different from the respective embodiments described above will be described. In this embodiment, raindrops are detected from the front image of the front monitoring camera 110. For this reason, as shown in FIG. 36, the lens unit 116 of the front monitoring camera 110 has a convex lens 122. The convex lens 122 is the first lens to which the light is incident among the plurality of lenses included in the lens unit 116.

The convex lens 122 shortens the focal length. Therefore, the focus of the infinity focus lens unit 116 can be adjusted to the windshield 200. This makes it possible to detect raindrops from the front image of the front monitoring camera 110.

Alternatively, as shown in FIG. 37, a lens 123 may be employed in which the central portion of the lens shape is open while the outer edge of the lens shape is focused on the windshield 200. That is, the central portion of the lens 123 has a view angle of focus at infinity, and the outer edge portion of the lens 123 has a view angle of focus on the windshield surface. The lens 123 is provided in the lens unit 116 of the front monitoring camera 110. Thereby, as shown in FIG. 38, the front monitoring camera 110 can be focused on both the windshield surface of the windshield 200 and infinity.

The present disclosure is not limited to the embodiments described above, and various modifications can be made as follows within a range not departing from the spirit of the present disclosure.

For example, as shown in FIG. 39, the front monitoring camera 110 and the raindrop detection camera 130 may be accommodated in the same casing 102. In other words, the raindrop detection camera 130 may be integrated with the front monitoring camera 110 so as not to be detachable.

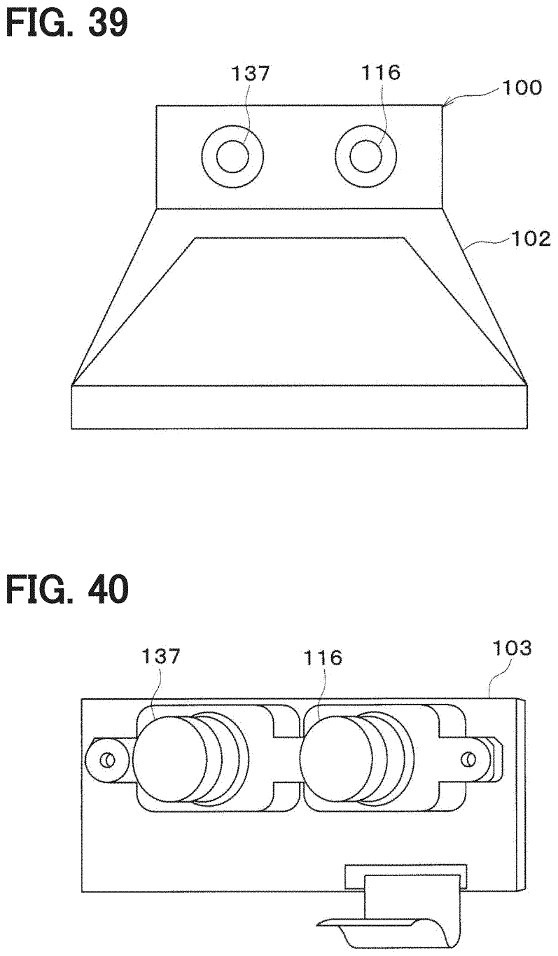

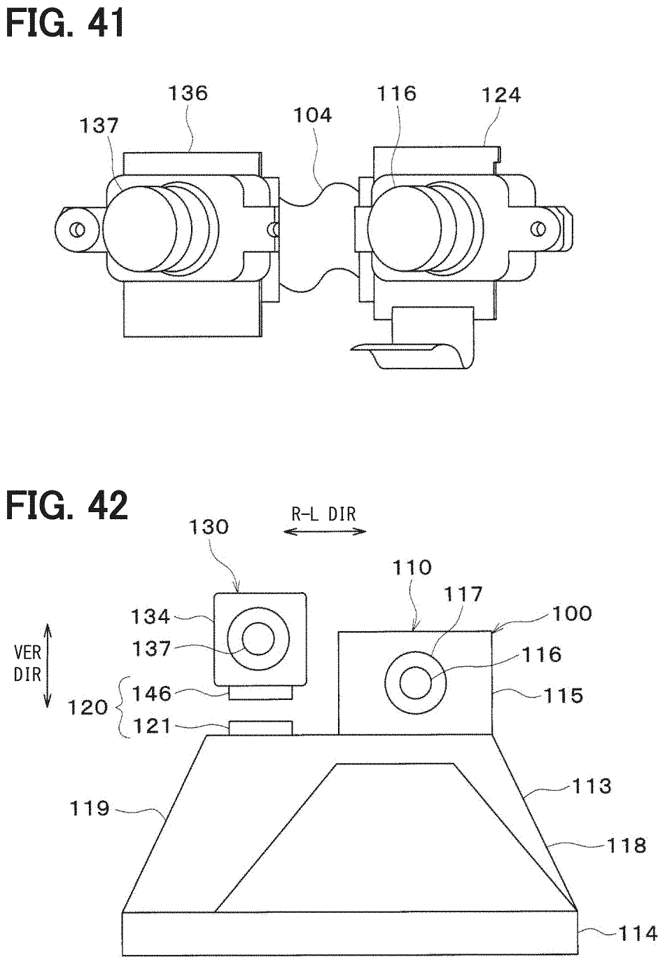

In this case, for example, as shown in FIG. 40, the imager 111 and the lens unit 116 of the front monitoring camera 110 and the imager 131 and the lens unit 137 of the raindrop detection camera 130 are mounted on the same circuit board 103. Alternatively, as shown in FIG. 41, the circuit board 124 of front monitoring camera 110 and the circuit board 136 of the raindrop detection camera 130 may be electrically connected by a flexible printed circuit board 104.

The image data of the front image output from the front monitoring camera 110 may not be directly input from the front monitoring camera 110 to the electronic control unit 150. That is, the image data of the front image may be input to the electronic control unit 150 via another device. The same applies to the image data of the windshield image.

In each of the embodiments described above, the raindrop detection camera 130 is attached to the front monitoring camera 110 in the right-left direction of the vehicle. This feature is merely an example. As shown in FIG. 42, the raindrop detection camera 130 may be mounted on the front monitoring camera 110 from the ceiling side to the ground side in the vertical direction.

Although the present disclosure has been described in accordance with embodiments, it is understood that the present disclosure is not limited to such embodiments or structures. The present disclosure incorporates various modifications and variations within the scope of equivalents. In addition, various combinations and forms, and other combinations and forms including only one element, more, or less than them are also included in the scope and concept of the present disclosure.

What is claimed is:

1. A raindrop detection device comprising:
a front monitoring camera for photographing a front of a vehicle through a windshield of the vehicle;
a raindrop detection camera for photographing a raindrop adhering to the windshield; and
an electronic control unit disposed away from the windshield, the front monitoring camera, and the raindrop detection camera, performing an image processing on an image data of a front image from the front monitoring camera, and performing an image processing on an image data of a windshield image from the raindrop detection camera, wherein:
the image data of the front image and the image data of the windshield image are output to the electronic control unit via a common signal line;
the raindrop detection camera has a humidity sensor that detects humidity and temperature of a vehicle compartment of the vehicle; and
information about the humidity and the temperature detected by the humidity sensor is output to the electronic control unit by being superimposed on the common signal line.

2. The raindrop detection device according to claim 1, wherein:
the electronic control unit recognizes the raindrop adhering to the windshield based on the image data of the windshield image, and determines a control of a wiper of the vehicle based on a recognition result.

3. The raindrop detection device according to claim 1, wherein:
the electronic control unit, based on the image data of the front image or the image data of the windshield image, determines at least one of:
a control of a wiper of the vehicle by detecting the raindrop adhering to the windshield;
whether a light of the vehicle are turned on or off by detecting an illuminance around the vehicle;
a control of an air-conditioner on a vehicle compartment by detecting an intensity and a direction of sun-light around the vehicle;
a control of a windshield washer that jets cleaning liquid to the windshield by detecting dirt on the windshield;
a control of a heater that warms a front side of the front monitoring camera and the raindrop detection camera; and
a control of a defroster that blows air toward the windshield.

4. The raindrop detection device according to according to claim 1, wherein:
the front monitoring camera has a front casing; and
the raindrop detection camera has a raindrop casing different from the front casing.

5. The raindrop detection device according to according to claim 1, wherein:
the front monitoring camera and the raindrop detection camera are electrically connected by a board-to-board connector.

6. The raindrop detection device according to according to claim 1, wherein:
the front monitoring camera has a front casing;
the raindrop detection camera has a raindrop casing different from the front casing; and
the raindrop casing of the raindrop detection camera has a fixing unit fixed to the front casing of the front monitoring camera.

7. The raindrop detection device according to according to claim 1, wherein:
the raindrop detection camera has a circuit board and a raindrop casing; and
the circuit board is assembled to the raindrop casing by any one of snap fit, press fit and heat crimp.

8. The raindrop detection device according to according to claim 1, wherein:
a part of a view angle of the front monitoring camera and a part of a view angle of the raindrop detection camera overlap.

9. The raindrop detection device according to according to claim 1, wherein:
the raindrop detection camera includes a circuit board and a humidity sensor mounted on the circuit board for detecting humidity and temperature in a vehicle compartment of the vehicle.

10. The raindrop detection device according to according to claim 1, wherein:
the electronic control unit estimates humidity of a windshield surface of the windshield based on information from a humidity sensor that detects the humidity and temperature of a vehicle compartment of the vehicle, and information from an outside temperature sensor that is mounted on the vehicle and detects an outside temperature around the vehicle.

11. The raindrop detection device according to according to claim 1, wherein:
the raindrop detection camera includes a raindrop casing and a humidity sensor accommodated in the raindrop casing and detecting humidity and temperature in a vehicle compartment of the vehicle; and
the raindrop casing of the raindrop detection camera has a through hole that connects an inside and an outside of the raindrop casing.

12. The raindrop detection device according to according to claim 1, wherein:
the raindrop detection camera is detachable from the front monitoring camera.

13. The raindrop detection device according to according to claim 1, wherein:
the raindrop detection camera is attached to the front monitoring camera from a ceiling side to a ground side in a vertical direction of the vehicle.

14. The raindrop detection device according to according to claim 1, wherein:
the raindrop detection camera has a depth of field corresponding to an inclination angle of the windshield.

15. The raindrop detection device according to according to claim 1, wherein:
the raindrop detection camera photographs the raindrop adhering to the windshield in a ground side range of a view angle in a vertical direction of the vehicle, and photographs a surrounding of the vehicle in a ceiling side range of the view angle in the vertical direction of the vehicle.

16. The raindrop detection device according to according to claim 1, wherein:
the raindrop detection camera changes a magnification of a raindrop detection range in a vertical direction and a magnification of other ranges in the windshield image to widen the raindrop detection range in the windshield image to be relatively wider than the other ranges.

17. The raindrop detection device according to according to claim 1, wherein:
the electronic control unit recognizes the raindrop included in the windshield image based on the windshield image;
the electronic control unit obtains a raindrop adhesion rate from a comparison between a total area of the windshield image and a total area of the raindrop included in the windshield image;
the electronic control unit estimates a rainfall amount based on the raindrop adhesion rate; and
the electronic control unit determines a control of a wiper of the vehicle according to the rainfall amount.

18. The raindrop detection device according to according to claim 1, wherein:
the electronic control unit determines a splash or a raindrop on the windshield based on the windshield image;
the electronic control unit determines a control of a wiper of the vehicle based on a determination result;
the electronic control unit determines whether the vehicle enters or exits a tunnel, based on the front image while the wiper of the vehicle is in operation;
the electronic control unit determines a control to stop operating the wiper of the vehicle immediately after entering the tunnel; and
the electronic control unit determines a control to increase a wiping speed of the wiper of the vehicle immediately after exiting the tunnel to be faster than a previously set wiping speed when the vehicle exits the tunnel.

19. The raindrop detection device according to according to claim 1, wherein:
the electronic control unit detects a water repellent state of the windshield based on a size and a numerical number of the raindrop included in the windshield image; and
the electronic control unit determines an operating speed of a wiper of the vehicle according to the water repellent state.

20. The raindrop detection device according to according to claim 1, wherein:
the electronic control unit determines brightness around the vehicle based on the front image or the windshield image; and
the electronic control unit determines a control of turning on and off a lights of the vehicle based on a determination result of the brightness.

21. The raindrop detection device according to according to claim 1, wherein:
the electronic control unit grasps a weather condition around the vehicle based on the front image or the windshield image; and
the electronic control unit transmits position information and the weather condition to a cloud server.
